(19) United States
(12) Patent Application Publication
(10) Pub. No.: US 2005/0286378 A1
(43) Pub. Date: Dec. 29, 2005

(54) Data writing method

(75) Inventors: Chien-Chun Ma, Hsinchu (TW); Ren-Chien Fu, Hsinchu (TW); Chia-Yuan Pang, Hsinchu (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/158,960

(22) Filed: Jun. 22, 2005

(30) Foreign Application Priority Data
Jun. 24, 2004 (TW) 093118352

(51) Int. Cl. G11B 11/03; G11B 5/09

(52) U.S. Cl. 369/53.15; 369/53.17; 369/47.14

(57) ABSTRACT

A data writing method is used with an optical recording apparatus to write data into a rewritable disc. For writing data, the optical recording apparatus enters a writing mode and a first packet is written into the rewritable disc. Then, the optical recording apparatus enters a detecting mode and data of the first packet written into the rewritable disc are read for defect detection. If no defect of the first packet is detected in the detecting mode, the writing mode is entered again, so a second packet can be written into the rewritable disc. On the other hand, if a defect of the first packet is detected in the detecting mode, a rewriting mode will be entered and the first packet is rewritten into the rewritable disc again.

### FIELD OF THE INVENTION

The present invention relates to a data writing method, and more particularly to a data writing method for use with an optical recording apparatus to write data into a rewritable disc such as Digital Video Disk-ReWritable (DVD-RW).

### BACKGROUND OF THE INVENTION

The use of optical recording apparatus such as CD or DVD recorder/rewriter provides a very convenient way for a user to maintain and access data. Nevertheless, lots of efforts have still been made or are to be made for further improvements in various aspects such as higher speed and accuracy in writing and reading, etc. Now, various optical discs are used for storing data for access, and include, for example, CD-R, CD-RW, DVD-R, DVD-RW, DVD+RW, etc. As known, the recordable discs like CD-R and DVD-R can be used to record data for only once, but the rewritable discs such as CD-RW, DVD-RW and DVD+RW can be utilized to repeatedly record and rewrite data. Commonly used writing modes include DAO (Disc-At-Once), SAO (Session-At-Once), Multi-Session Writing, TAO (Track-At-Once) and Packet-Writing, etc.

In the DAO mode, data are continuously written into a disc from “lead-in” to “lead-out”. It is advantageous of no gap between tracks and no linking issues to be handled. In addition, the laser head used in this mode is kept on and the duplicated discs will have identical capacity to the original disc. Since all data written into the disc are continuous and relevant, the data is possibly unable to be correctly read once there is error occurring in the writing process.

The SAO mode, like the DAO mode, will result in no gap between tracks. The SAO writing procedure starts with writing a couple of tracks into the first session, and then suspends the laser head for a while. Meanwhile, the disc is still available for further writing operation. That is, the disc recorder or rewriter can still write data into the blank region of the disc. Afterwards, the SAO writing procedure goes on to write data into next session. In the case that only one writing session processed only for the disc, there is no difference between the SAO mode and the DAO mode.

In the TAO mode, data are written track by track. Accordingly, there will be gaps between tracks. After completing a track of data, the laser head suspends, and then starts again for next track. Between tracks, the writing operation is interrupted and a buffering blank region is reserved to assure the integrity of each track of data. In the writing process, two “run-out” blocks are added when writing is completed for one track. When the laser head is re-actuated for next track, one “link” and four “run-in” blocks are defined, and data are written subsequently.

The Packet-Writing mode differs from the above mentioned modes such as DAO or TAO mode in that each time data are written in fewer blocks. Generally, it can be classified into a Fix-size PacKet Write (FPKT-Write) mode and a Variable-size PacKet Write (VPKT-Write) mode. In the FPKT-Write mode, all packets in the data region have to be with the same number and size of tracks or blocks. On the other hand, for the VPKT-Write mode, the number of blocks in a packet can be adjusted according to data size. Like the TAO mode, there is “link”, “run-in” and “run-out” blocks defined to facilitate continuous reading over different packets. Further, it is advantageous of minimizing discarded space and/or incorrectly read region size resulting from defects.

Comparing the above-mentioned modes, it is understood that writing and reading errors can be reduced by using the Packet-Writing mode because the written unit of the Packet-Writing mode is much smaller than that of the other modes. The writing and reading performance of the optical recording/reproducing apparatus can be further improved by introducing defect management into the writing process. The blocks determined as defective ones according to the defect management will not leave as available spaces in subsequent writing operations. Normal blocks, however, may be improperly determined “defective” due to some unexpected factors, e.g. physical vibration or unstable servo control. In other words, lots of misjudged “defective” blocks are sacrificed although they are likely to be determined normal if detected again.

### SUMMARY OF THE INVENTION

Therefore, the present invention provides a data writing method for use with a rewritable disc, capable of making use of the disc space while keeping high reading and writing accuracy.

The present invention provides a data writing method for use with an optical recording apparatus to write data into a rewritable disc. In an embodiment, a writing mode is entered and a first packet is written into the rewritable disc, a detecting mode is entered and data of the first packet written into the rewritable disc is read for defect detection, then the writing mode is entered again and a second packet is written into the rewritable disc when no defect of the first packet is detected in the detecting mode, or a rewriting mode is entered and the first packet is written into the rewritable disc again when a defect of said first packet is detected in said detecting mode.

Preferably, a lead-in portion is generated on the rewritable disc before any written packet and a lead-out portion on the rewritable disc after all written packets. And in the rewriting mode, the first packet written into the rewritable disc is erased before written into the rewritable disc again. The first packet and second packet are written into a buffer and then transferred to the rewritable disc. Accordingly, the first packet can have been stored in the buffer be transferred to the rewritable disc in the rewriting mode.

The writing mode, for example, is suitably a Fix-size PacKet Write (FPKT-Write) mode. In general, the first packet written in the writing mode includes link, run-in, data and run-out groups. Then, it is preferred that all of the link, run-in, data and run-out groups are rewritten in the rewriting mode.

In an embodiment of performing the detecting mode, a sub-beam addition signal is generated in response to the light reflected from a currently detected block of the rewritable disc, a low pass filtering operation of the sub-beam addition signal is performed to obtain a low pass sub-beam addition signal, and the currently detected block is determined as defective when an absolute value of an intensity difference between the sub-beam addition signal and the low pass sub-beam addition signal is greater than a threshold value.

In an embodiment, the detecting mode and the rewriting mode are repeated for a predetermined number of times or until no defect of the first packet is detected. The data writing method can further comprise a step of informing a host of writing failure when there is still a defect of the first packet detected after repeating the detecting mode and the rewriting mode for the predetermined number of times.

In an embodiment, the data writing method further comprises a step of writing the first packet to an alternative blank region of the rewritable disc when the writing failure is determined.

The present invention also relates to a data writing method for use with an optical recording apparatus to write data into a rewritable disc, comprising steps of:
a) entering a writing mode and writing a first packet into the rewritable disc;
b) entering a detecting mode and reading data of the first packet written into the rewritable disc for defect detection;
c) entering a rewriting mode and writing the first packet into the rewritable disc again when a defect of the first packet is detected in the detecting mode;
d) repeating the step b) and c) after the step c) and accumulatively counting when the first packet is rewritten until no defection of the first packet is detected in the detection mode or a predetermined counted value is due;
e) entering the writing mode again and writing a second packet into the rewritable disc when no defection of the first packet is detected in the detection mode.

In an embodiment, the data writing method further comprises a steps of informing a host of writing failure when said predetermined counted value in said step e) is due and there is still a defect of said first packet detected, and then writing the first packet to an alternative blank region of the rewritable disc when the writing failure is determined.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic diagram illustrating data written in Packet-Writing mode;

FIG. 1B is a schematic diagram illustrating the contents of a packet of FIG. 1A;

FIG. 2 is a flowchart illustrating an embodiment of a data writing method according to the present invention;

FIG. 3 is a functional block diagram illustrating a data processing system of an optical disc drive; and

FIG. 4 is a flowchart illustrating a method for determining defective blocks.

### DETAILED DESCRIPTION OF THE PREFERRED EMBODIMENT

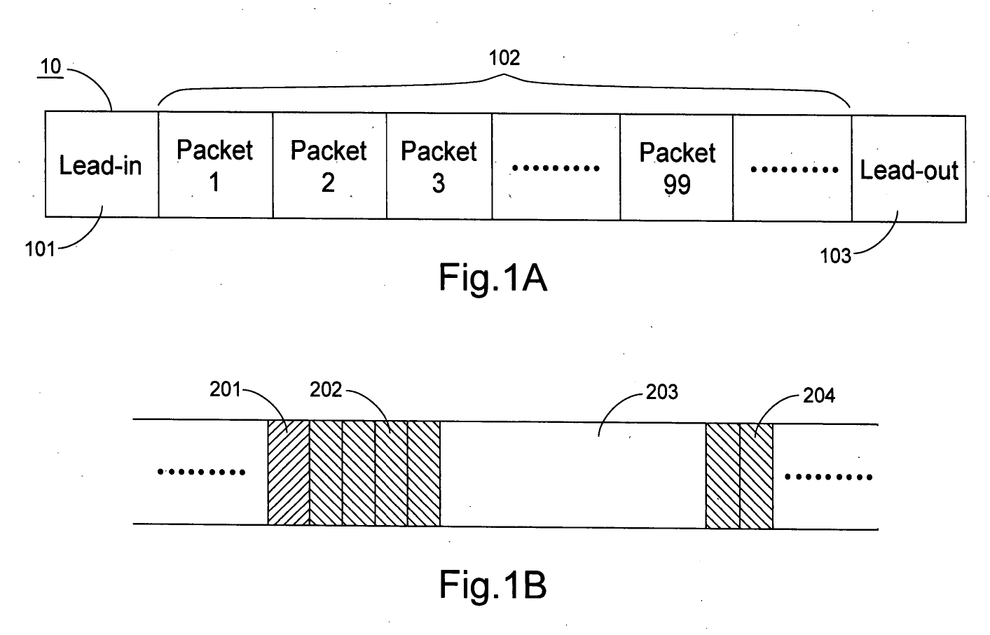

Hereinafter, a data writing method according to the present invention is illustrated according to discs with CD-RW format. With reference to FIG. 1A, a typical writing operation of a Packet-Writing mode is illustrated. The writing operation starts with a lead-in portion 101 and ends with a lead-out portion 103, and data packets 102 are written into an optical disc one by one between the lead-in portion 101 and the lead-out portion 103. In one of the packets 102, a link block 201, a run-in group 202, a data group 203 and a run-out group 204 are included, as illustrated in FIG. 1B. The number of blocks included in the data group 203 is variable. However, if the FPKT-Write mode is adapted, each data group will have the same number of blocks. In an example, the run-in group 202 consists of four identical blocks, the data group consists of 32 blocks and the run-out group 204 consists of 2 identical blocks.

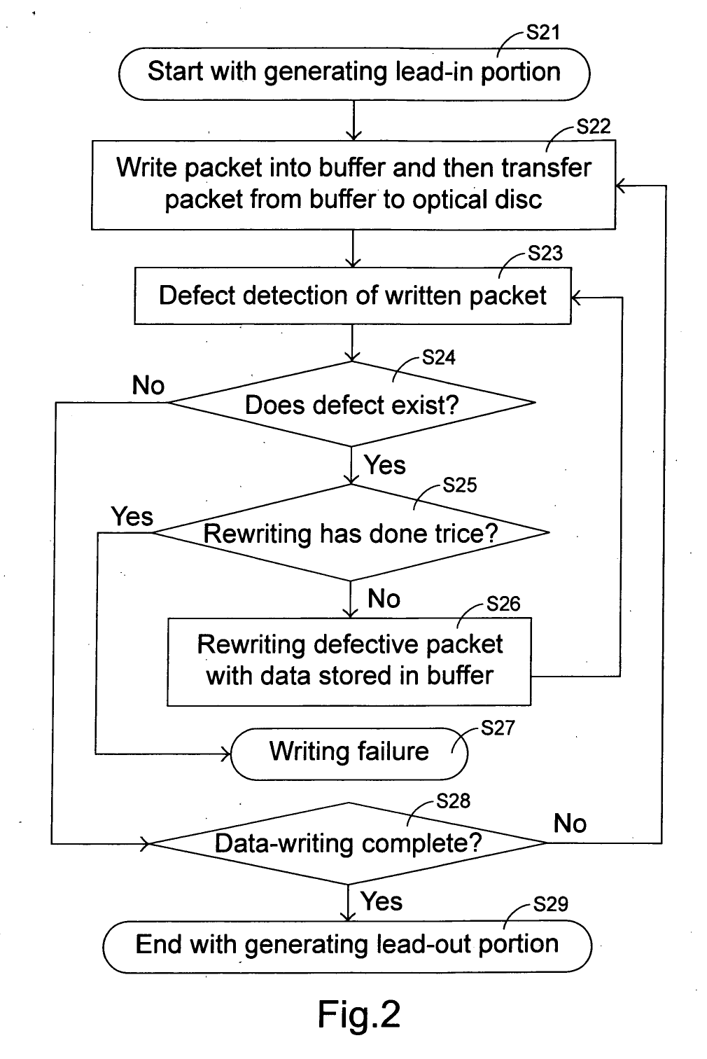

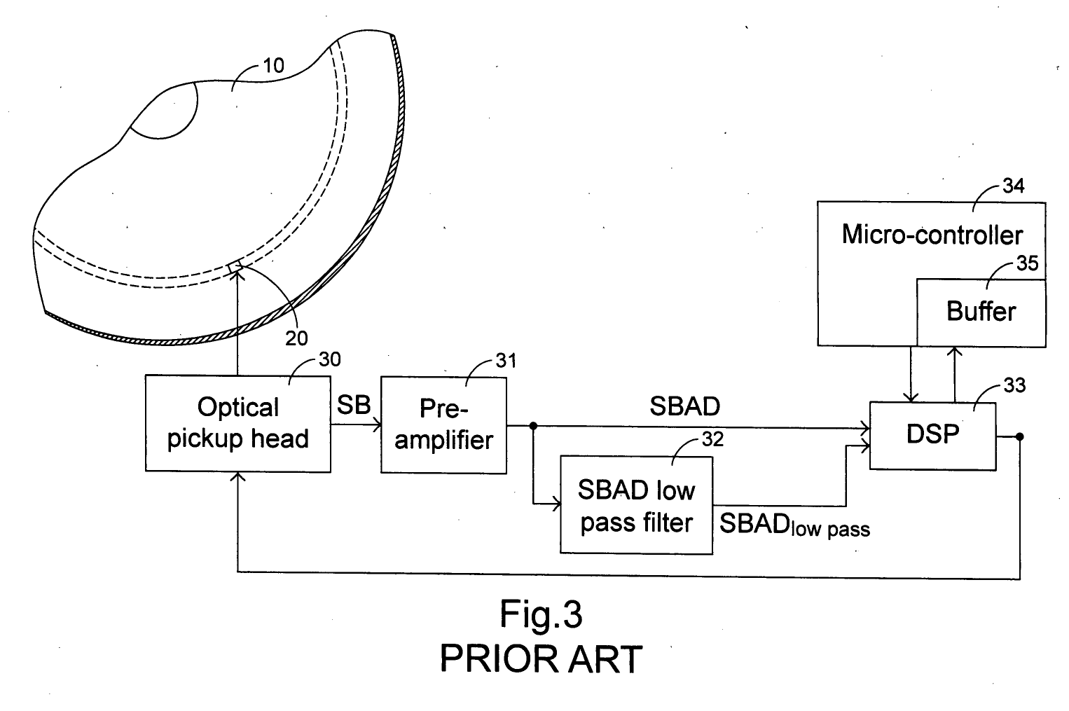

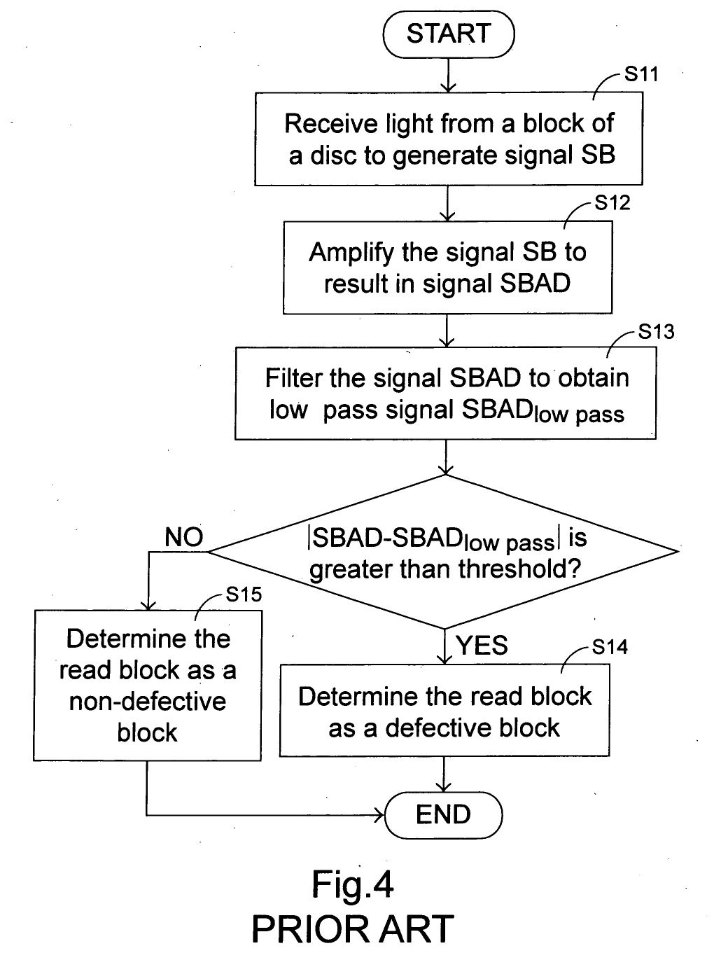

The flowchart of FIG. 2 is used to illustrate an embodiment of the data writing method of the present invention. First of all, the optical recording apparatus defines a lead-in portion in a rewritable optical disc, and then enters a writing mode (Step S21). In the writing mode, a data packet is written into the optical disc (Step S22). In the FPKT-Write mode, packets to be recorded into the optical disc are written into a buffer first and then transferred to the optical disc. Afterwards, the optical recording apparatus enters a detection mode (Step S23) to detect whether there is any defect in the packet written into the optical disc (Step S24). The defect detection method can be any suitable one for determining defective blocks. Among various kinds of defect detecting methods, one method is illustrated with reference to the devices of FIG. 3 and flowchart of FIG. 4.

Referring to FIG. 3, the optical recording apparatus comprises an optical pickup head 30, a pre-amplifier 31, a sub-beam addition signal (SBAD) low pass filter 32, a digital signal processor (DSP) 33 and a micro-controller 34. In the micro-controller 34, a buffer 35 is provided for storing data packets temporarily. The optical pickup head 30 has several light receiving parts (not shown) for respectively receiving the light reflected from one of the blocks of a disc 10, e.g. block 20, and producing sub-beam signals SB (Step S11, FIG. 4). These sub-beam signals SB are amplified through the pre-amplifier 31 to generate a sub-beam addition signal SBAD (Step S12). The sub-beam addition signal SBAD is substantially the summation partial or all of these sub-beam signals. The sub-beam addition signal SBAD is then filtered by the SBAD low pass filter 32 to generate a low pass signal SBAD_{low pass} (Step S13). If an absolute value of |SBAD−SBAD_{low pass}| is greater than a threshold value, the block is determined to be defective (Step S14), or otherwise, non-defective (Step S15).

If the packet written into the optical disc is determined to be non-defective in Step S24, the optical recording apparatus will enter the writing mode again and the writing operation will go on for next packet. On the other hand, once the packet written into the optical disc is determined to be defective in Step S24, that defective packet having been written in the optical disc will be erased, and the optical recording apparatus will enter a rewriting mode to rewrite that packet (Step S26). The rewriting procedure is implemented with the data packet previously stored in a buffer, e.g. the buffer 35 integrated in the micro-controller 34 as shown in FIG. 3, and performed for all blocks from the link block through the run-out blocks. After the packet has been rewritten into the optical disc, the detection mode is entered again. Still, the rewriting procedure needs to be performed once defection is detected. The multiple check of defection will be performed predetermined times (Step S25) and then given up (Step S27). For example, it can be preset to perform the defection check three times at most. In other words, if a certain packet has been repeatedly written/rewritten thrice and still determined defective, it is likely that there is a problem on the optical disc itself that cannot be made up by rewriting data. Therefore, the rewriting operation of that packet will be ended and the host will be informed of the writing failure. Depending on how the writing program on the host is configured, the writing procedure can be suspended by the host or the packet can be written into an alternative blank region of the optical disc.

On the other hand, after the packet is written or rewritten successfully without defection detected, next packet will be written into the buffer and then recorded into the optical disc by repeating the above steps. Likewise, the newly written packet has to be detected for defects and subject to rewriting and/or other reprocessing steps, if necessary. When all the data have been recorded in the optical disc (Step S28), a lead-out portion is generated to complete writing (Step S29).

By introducing a detecting procedure to check whether the written packet is defective, the defects, if any, can be made up in time before the writing operation proceeds to next packet. Therefore, the correctness of data can be assured. Furthermore, by rewriting the packet a couple of times before giving up the defective block(s), the misjudgment of defective space of the optical disc can be minimized. Moreover, since the rewriting procedure is implemented with the data packet previously stored in the buffer, it won't take too much time to do the rewriting operation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A data writing method for use with an optical recording apparatus to write data into a rewritable disc, comprising steps of:
entering a writing mode and writing a first packet into the rewritable disc;
entering a detecting mode and reading data of said first packet written into the rewritable disc for defect detection;
entering said writing mode again and writing a second packet into the rewritable disc when no defect of said first packet is detected in said detecting mode; and
entering a rewriting mode and writing said first packet into the rewritable disc again when a defect of said first packet is detected in said detecting mode.

2. The data writing method according to claim 1 further comprising steps of:
generating a lead-in portion on the rewritable disc before any written packet; and
generating a lead-out portion on the rewritable disc after all written packets.

3. The data writing method according to claim 1, wherein said rewriting mode further comprising a step to erase said first packet written into the rewritable disc before writing said first packet into the rewritable disc again.

4. The data writing method according to claim 1, wherein in said writing mode, said first packet is written into a buffer and then transferred to the rewritable disc.

5. The data writing method according to claim 1 wherein in said writing mode, said second packet is written into a buffer and then transferred to the rewritable disc.

6. The data writing method according to claim 4, wherein said first packet having been stored in said buffer is transferred to the rewritable disc in said rewriting mode.

7. The data writing method according to claim 1, wherein said writing mode is a Fix-size PacKet Write (FPKT-Write) mode.

8. The data writing method according to claim 1, wherein said first packet written in said writing mode includes link, run-in, data, and run-out groups, and all of said link, run-in, data, and run-out groups are rewritten in said rewriting mode.

9. The data writing method according to claim 1, wherein in said detecting mode further comprises:
generating a sub-beam addition signal in response to the light reflected from a currently detected block of the rewritable disc; and
performing a low pass filtering operation of said sub-beam addition signal to obtain a low pass sub-beam addition signal
wherein said currently detected block is determined as defective when an absolute value of an intensity difference between said sub-beam addition signal and said low pass sub-beam addition signal is greater than a threshold value.

10. The data writing method according to claim 1 further comprising a step of repeating said detecting mode and said rewriting mode for a predetermined number of times or until no defect of said first packet is detected.

11. The data writing method according to claim 10 further comprising a step of informing a host of writing failure when there is still a defect of said first packet detected after repeating said detecting mode and said rewriting mode for said predetermined number of times.

12. The data writing method according to claim 11 further comprising a step of writing said first packet to an alternative blank region of the rewritable disc when said writing failure is determined.

13. A data writing method for use with an optical recording apparatus to write data into a rewritable disc, comprising steps of:
a) entering a writing mode and writing a first packet into the rewritable disc;
b) entering a detecting mode and reading data of said first packet written into the rewritable disc for defect detection;
c) entering a rewriting mode and writing said first packet into the rewritable disc again when a defect of said first packet is detected in said detecting mode;
d) repeating said step b) and c) after said step c) and accumulatively counting when said first packet is rewritten until no defection of said first packet is detected in said detection mode or a predetermined counted value is due; and
e) entering said writing mode again and writing a second packet into the rewritable disc when no defection of said first packet is detected in said detection mode.

14. The data writing method according to claim 13, wherein in said step c), said first packet written into the rewritable disc is erased and then written again.

15. The data writing method according to claim 13, wherein in said steps a) and e), said first packet and second packet are written into a buffer and then transferred to the rewritable disc.

16. The data writing method according to claim 15, wherein in said step c), said first packet having been stored in said buffer is transferred to the rewritable disc in said rewriting mode.

17. The data writing method according to claim 13, wherein said writing mode is a Fix-size PacKet Write (FPKT-Write) mode.

18. The data writing method according to claim 13, wherein said first packet written in said writing mode includes link, run-in, data and run-out groups, and all of said link, run-in, data and run-out groups are rewritten in said rewriting mode.

19. The data writing method according to claim 13 further comprising a step of informing a host of writing failure when said predetermined counted value in said step e) is due and there is still a defect of said first packet detected.

20. The data writing method according to claim 19 further comprising a step of writing said first packet to an alternative blank region of the rewritable disc when said writing failure is determined.
